(19) United States
(12) Patent Application Publication
(10) Pub. No.: US 2010/0163352 A1
(43) Pub. Date: Jul. 1, 2010

(54) SINTERED BRAKE PAD BACKING PLATE

(76) Inventor: Marcos Minoru Umeda, Hortolandia (BR)

Correspondence Address: QUARLES & BRADY LLP, 411 E. WISCONSIN AVENUE, SUITE 2040, MILWAUKEE, WI, 53202-4497, US

(21) Appl. No.: 12/526,754

(22) PCT Filed: Feb. 8, 2008
(86) PCT No.: PCT/US08/53413

§ 371 Date: Feb. 18, 2010

Related U.S. Application Data
(60) Provisional application No. 60/901,897, filed on Feb. 16, 2007.

(51) Int. Cl. F16D 69/00

(52) U.S. Cl. 188/250 B

(57) ABSTRACT

A brake pad backing plate made using powder metallurgy has an inner surface to which a friction material mass is attached and which cooperates with the mass to resist shearing of the mass relative to the plate. Formations can be made on the inner surface that resist shearing of the friction material mass from the backing plate, the mass can have mating formations and the plate can be steam treated for additional benefits.

### CROSS-REFERENCE TO RELATED APPLICATION

This application claims the benefit of U.S. Provisional Patent Application No. 60/901,897 filed on Feb. 16, 2007, which is hereby incorporated by reference.

### STATEMENT CONCERNING FEDERALLY SPONSORED RESEARCH OR DEVELOPMENT

Not applicable.

### FIELD OF THE INVENTION

This invention relates to brake pads, and in particular to brake pads for disc brakes in which a friction material mass is attached to a backing plate.

### BACKGROUND OF THE INVENTION

FIG. 1 illustrates a typical disc brake system assembly S for a vehicle, in which a metal disc D that rotates with the wheel hub H is pinched between two brake pads P to slow down or stop the vehicle. Referring also to FIG. 2, the brake pads P are held in brake calipers C which are fixed relative to the vehicle chassis, but permit the brake pads P to float or be moved toward or away from the disc D. The calipers hold the pads P so that they cannot rotate relative to the disc D. One or more hydraulic piston actuators A that are part of the calipers exert force on the back of the brake pads P to pinch the disc D between the two pads P when the brake pedal is pushed.

Referring to FIG. 3, the brake pads P each consist of a braking element called “mass” M and a backing plate B. The mass M is a friction material, that may be, for example, a mixture of organic and inorganic materials, fibers and phenolic resin, or a sintered material. The backing plate B is typically a steel plate, usually made by a metal stamping process, and is typically joined by an adhesive, rivets or other fasteners to the mass M. Brake pads come in many different shapes and sizes, dictated by the particular application, and different shapes are shown in FIGS. 2-4.

The brake pad backing plate B must withstand compressive stresses from the action of the hydraulic cylinder of the caliper, without any deformation, and must do so in adverse environmental conditions. Although the mass M acts as a heat insulator, the backing plate B can still experience high temperatures. Also, the plate B should not normally contact the rotating disc D, but this may occur if the mass M is worn out. This generates high wear of the disc and plates and a loud noise to alert the operator to fix the brakes. The plate B must also withstand salt spray and hot and cold temperature extremes normally found in varying climates.

### SUMMARY OF THE INVENTION

The present invention provides a powder metal backing plate for a brake pad which results in a backing plate with advantages over presently known backing plates. In a brake pad of the invention, the backing plate is made of powder metal, which enables desirable features to be incorporated into the backing plate.

In one aspect, the invention enables making shapes on the plate surface to help anchor the friction material mass.

The invention does this while delivering a backing plate of exceptional quality and cost. Prior manufacturing processes have required oil and dirt blasting to allow subsequent processing, and sometimes surface plating. The present invention reduces the subsequent processing required. For example, parts made according to the present invention can be easily steam treated to provide oil and dirt free parts, which is a more environmentally friendly process than conventional processes for cleaning and plating stampings. The present invention also reduces waste, which was relatively high in prior fineblanking and conventional stamping processes.

In addition, the present invention reduces the capitol investment in presses and tooling for making brake pad backing plates.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a side view of a typical disc brake system for a vehicle;

FIG. 2 is a cross-sectional view of typical calipers and brake pads for a disc brake system such as that shown in FIG. 1;

FIG. 3 is a perspective view of a disc brake pad for a disc brake system, illustrating the backing plate and the friction material mass of the brake pad; this view would look essentially the same whether the backing plate is made using the invention or not;

FIG. 4 is a perspective view of a typical brake pad backing plate showing the inner surface that is mated with the friction material mass of the brake pad;

FIG. 5 is a view like FIG. 4 but of a backing plate incorporating the invention;

FIG. 6 is a perspective view of the outer side of either the plate of FIG. 4 or the plate of FIG. 5, showing the side that is opposite from the friction material mass, which could look essentially the same for either plate.

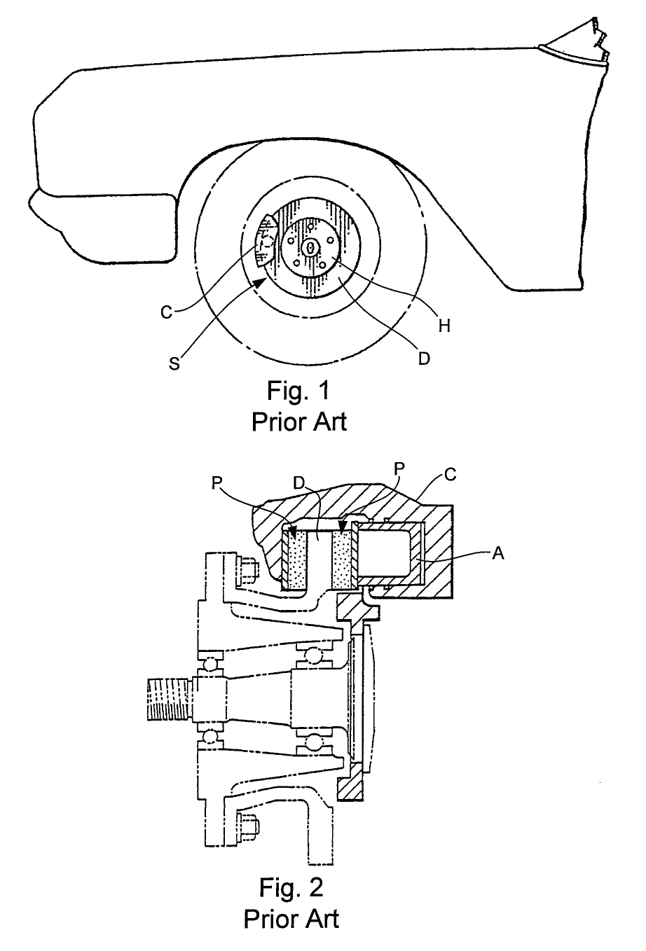

### DETAILED DESCRIPTION OF THE PREFERRED EMBODIMENT

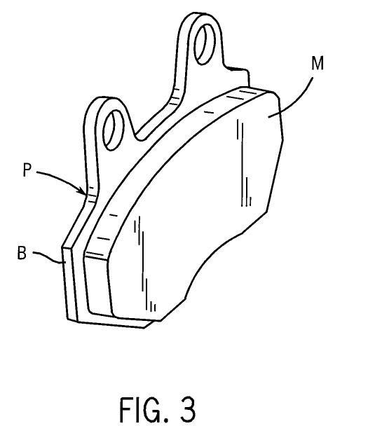

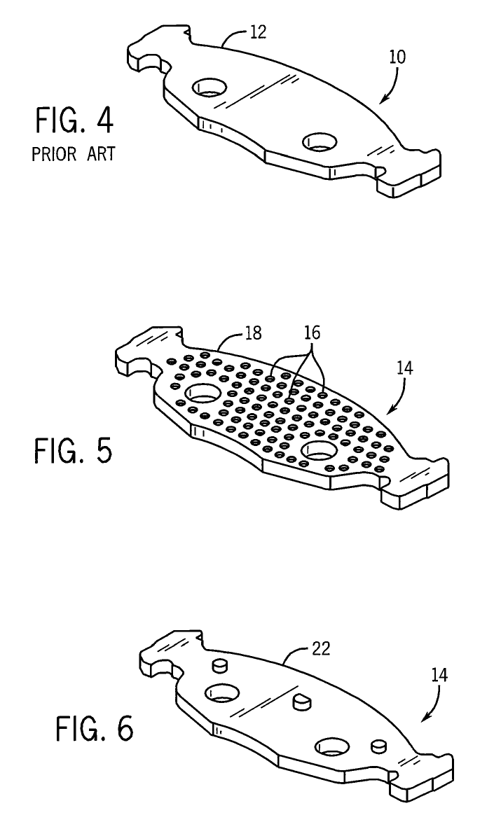

FIG. 4 is a perspective view of a typical brake pad backing plate 10 showing the inner surface 12 that is mated with a friction material mass (not shown in FIG. 4, but shown in FIGS. 2 and 3) of a brake pad. As can be seen, the inner surface 12 is flat and smooth. As such, the surface 12 itself does not have any mechanical engagement with the mass. It has been recognized in stamped plates that the surface 12 may desirably include burrs or other formations that can be raised from the surface 12 which require additional tooling and/or additional manufacturing steps.

FIG. 5 illustrates a brake pad backing plate 14 incorporating the present invention. The plate 14 is made using a sintered powder metal process. With this process, formations 16 can be formed on the inner surface 18 that can create a mechanical interference or form fit with the friction material mass. These formations are formed when the powder metal of the plate 14 is pressed, prior to sintering, in molding dies into a powder metal compact. Typical densities achievable in the compact are 6.2 to 6.8 g/cm³ or higher. The pressing process of making powder metal compacts is well known, as is the sintering process, in which the compacts are sintered at high temperature in a controlled atmosphere to bond the particles metallurgically, which makes the plate structurally very hard and rigid, and capable of acting as the foundation of a brake pad.

A suitable powder metal material for the plate 14 is an iron-copper-carbon powder such as FC-0208 or and iron-carbon powder such as FC-0008. Other powders could also be used, for example to produce particular properties or characteristics in the plate that such powders are known to yield.

The sintering process results in a part which is clean and oil free, but in addition the part can be steam treated which yields additional benefits. Steam-treatment involves exposing the part at a temperature around 500° C. to high pressure steam if done in a batch process, or to steam at an elevated pressure if done in a continuous or line process. This leads to the formation of a layer of magnetite (iron oxide—Fe₃O₄) on the steam treated surfaces. This is desirable because the treated part is clean and oil free, corrosion resistance and compressive strength is improved, and the surface hardness and wear resistance is increased.

The formations 16 are small depressions or dimples in the backing plate 14 formed in the surface 18. There can be multiple such formations 16 as illustrated, or fewer. In addition, the formations 16 could possibly be formed as small projections, although dimples are presently preferred. If dimples are used, the friction material mass can have a flat surface that mates to the surface 18, and the edges of the formations 16 will help to hold the mass against shearing. Alternatively, the mass may be formed to have a mating set of projections that extend into the set of formations 16 for a more positive resistance against shearing. As another alternative, the mass may be pressed against the surface 18 with sufficient pressure to extrude a portion of the surface of the mass into the formations 16, which also helps to resist shearing of the mass relative to the plate 14. If the formations 16 are projections rather than depressions, mating depressions could be formed in the mass to mate with the projections from the surface 18, but pressing the mass against the surface or bonding it directly without significant pressing could be more problematic.

The mass, in addition or as an alternative to being mated with mating formations, pressed on or bonded to the plate, could be attached to the plate 14 with fasteners such as rivets or bolts.

FIG. 6 illustrates the outer side surface 22 of the plate 14. This surface may be the same as the outer side surface of the prior art plate 10.

Thus, the invention provides a brake pad backing plate that is made using powder metallurgy that yields substantial benefits. The plate has an inner surface to which a friction material mass is attached. In this regard, the plate is inherently clean and free of oil and dirt as a result of making it from powder metallurgy. It can also be steam treated to yield additional advantages in hardness, compressibility, corrosion resistance and cleanliness. In addition, formations can be made in the inner surface that resist shearing of the friction material mass from the backing plate.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. A brake pad backing plate comprising powder metal particles pressed together and metallurgically bonded in a shape that resists shearing movement of a brake pad friction material mass relative to the plate.

2. A brake pad backing plate as in claim 1, wherein the plate includes formations on an inner surface against which the brake pad friction material mass is attached that resist shearing movement of the brake pad friction material mass, the formations being made of metal particles metallurgically bonded together and being integral with a remainder of the plate.

3. A brake pad backing plate as in claim 2, wherein the formations are depressions.

4. A brake pad backing plate as in claim 1, wherein the brake pad friction material mass is shaped to mate with the plate.

5. A brake pad backing plate is in claim 4, wherein the plate includes formations on an inner surface against which the brake pad friction material mass is attached and the brake pad friction material mass has formations that mate with the formations of the plate to resist shearing movement of the brake pad friction material mass relative to the plate.

6. A brake pad backing plate as in claim 5, wherein the formations on the plate are depressions.

7. A brake pad backing plate as in claim 6, wherein the brake pad friction material mass has projections that mate with the depressions on the plate.

8. A brake pad backing plate as in claim 2, wherein the formations are pressed into shape when the plate is pressed into shape.

9. A brake pad backing plate as in claim 5, wherein the brake pad friction material mass is pressed against the inner surface of the plate to extrude a portion of the brake pad friction material mass into the formations on the plate.

10. A brake pad backing plate as in claim 1, wherein a powder metal compact that forms the brake pad backing plate after sintering has a density in the range of 6.2 to 6.8 g/cm³.

11. A brake pad backing plate as in claim 1, wherein the brake pad backing plate is made of a material selected from the group of FC-0208 and FC-0008.

12. A brake pad backing plate as in claim 1, wherein the brake pad backing plate is steam treated after sintering.

13. A brake pad backing plate as in claim 1, wherein the brake pad backing plate includes an inner surface with a layer of iron oxide.
